(19) United States
(12) Patent Application Publication
(10) Pub. No.: US 2025/0182342 A1
(43) Pub. Date: Jun. 5, 2025

(54) IMAGE PROCESSING APPARATUS FOR GENERATING CG IMAGE OF WHICH OPTICAL CONSISTENCY WITH REAL SPACE IS IMPROVED, AND CONTROL METHOD OF IMAGE PROCESSING APPARATUS

(71) Applicant: CANON KABUSHIKI KAISHA, Tokyo (JP)

(72) Inventor: MASATO OGAWA, Tokyo (JP)

(21) Appl. No.: 18/965,153

(22) Filed: Dec. 2, 2024

(30) Foreign Application Priority Data
Dec. 5, 2023 (JP) 2023-205032

(51) Int. Cl. G06T 11/00; G06T 7/70

(52) U.S. Cl. CPC G06T 11/00; G06T 7/70; G06T 2207/30244

(57) ABSTRACT

An image processing apparatus includes one or more processors and/or circuitry configured to: perform a first acquiring processing to acquire information on a position and attitude of an imaging apparatus that captures an image of a real space; perform a second acquiring processing to acquire information on parameters on image processing, with the parameters being associated with the position and attitude of the imaging apparatus, from an environment map; and perform a generation processing to generate an image of an object to be displayed in the real space, based on the information on the position and attitude of the imaging apparatus, and the information on the parameters, wherein in the first acquiring processing, the position and attitude of the imaging apparatus is estimated from a captured image of the real space, by using the environment map.

### BACKGROUND OF THE INVENTION

### Field of the Invention

The present invention relates to an image processing apparatus for generating a CG image of which optical consistency with a real space is improved, and a control method of the image processing apparatus.

### Description of the Related Art

In recent years research on mixed reality (MR) aiming at the seamless integration of a real space and a virtual space is ongoing. As an MR technique, a technique using a video see-through type head-mounted display (HMD) is known. In the video see-through type HMD, a computer graphics (CG) image generated in accordance with a position and attitude of an imaging apparatus (e.g. video camera) is superimposed on a real space image captured by the imaging apparatus, and displayed. The user can observe the image, generated by superimposing and displaying the CG image on the real space image, via HMD.

In processing such as estimating the position and attitude of the imaging apparatus and rendering the CG image, a high load operation is performed. The video see-through type HMD displays an image after performing this arithmetic processing. Therefore, in some cases, a delay is generated in display of the CG image. On the other hand, another method proposed displays a captured real space image without waiting for completion of estimating the position and attitude and completion of rendering the CG image, and separately combining the CG image after performing a series of processing. If this method is used, the delay of displaying the real space image is reduced. However, delay is generated to display the CG image, hence display of the CG image delays from the real space image, and position and attitude of the real space image and those of the CG image deviate when observed. Japanese Patent Application Publication No. 2019-95916 discloses a method for performing re-projection processing on a CG image based on the time stamp, so as to reduce the deviation of the position and attitude between the real space image and the CG image when observed.

In some cases, if a CG image is superimposed without modification on a real space image in the video see-through type HMD, a visually unnatural image may be generated. This is because when image characteristics, such as gradation, white balance, noise, resolution and gamma value, are different between the real space image and the CG image, the combined image of the real space image and the CG image cannot establish optical consistency.

The real space image is an image generated by limiting the dynamic range of the real space to a dynamic range of the imaging apparatus, which is narrower than the dynamic range of the real space. Therefore, a subject, which exists in front of a bright white wall exposed to the sun, is imaged to be darker than it actually looks. The CG, on the other hand, of which brightness can be adjusted to be displayed optimally on the computer display, regardless the ambient environment, can be reproduced very well even in a bright state in front of a white wall. This means that the combined image simply displaying, side-by-side, the subject in front of a white wall and the CG image becomes an unnatural image without optical consistency, due to the difference of brightness between the subject and the CG image.

Japanese Patent Application Publication No. 2014-203326 and Japanese Patent Application Publication No. 2018-49614 disclose methods to reduce the unnaturalness generated due to the optical inconsistency.

However if there is a deviation between a timing to display the real space image and a timing to display the CG image, there is also a deviation between the timings to apply parameters of image processing to adjust image characteristics, also deviate. The parameters of the image processing are immediately applied to the real space time, but the parameters appear to be applied with a delay to the CG image, since there is a time lag until the CG image is displayed.

### SUMMARY OF THE INVENTION

The present invention provides an image processing apparatus that can generate a CG image of which optical consistency with the real space is improved.

A first aspect of the present invention is an image processing apparatus including one or more processors and/or circuitry configured to: perform a first acquiring processing to acquire information on a position and attitude of an imaging apparatus that captures an image of a real space which is a visual field of a user; perform a second acquiring processing to acquire information on parameters on image processing, with the parameters being associated with the position and attitude of the imaging apparatus, from an environment map in which a captured image, information on the position and attitude, and information on the parameters on image processing are associated with each other; and perform a generation processing to generate an image of an object to be displayed in the real space, based on the information on the position and attitude of the imaging apparatus acquired in the first acquiring processing, and the information on the parameters acquired in the second acquiring processing, wherein in the first acquiring processing, the position and attitude of the imaging apparatus is estimated from a captured image of the real space, by using the environment map.

A second aspect of the present invention is a control method of an image processing apparatus, the control method including: a first acquiring step of acquiring information on a position and attitude of an imaging apparatus that captures an image of a real space which is a visual field of a user; a second acquiring step of acquiring information on parameters on image processing, with the parameters being associated with the position and attitude of the imaging apparatus, from an environment map in which a captured image, information on the position and attitude, and information on the parameters on image processing are associated with each other; and a generation step of generating an image of an object to be displayed in the real space, based on the information on the position and attitude of the imaging apparatus acquired in the first acquiring step, and the information on the parameters acquired in the second acquiring step, wherein in the first acquiring step, the position and attitude of the imaging apparatus is estimated from a captured image of the real space, by using the environment map.

A third aspect of the present invention is a non-transitory computer-readable medium storing a program, wherein the program causes a computer to execute the control method including: a first acquiring step of acquiring information on a position and attitude of an imaging apparatus that captures an image of a real space which is a visual field of a user; a second acquiring step of acquiring information on parameters on image processing, with the parameters being associated with the position and attitude of the imaging apparatus, from an environment map in which a captured image, information on the position and attitude, and information on the parameters on image processing are associated with each other; and a generation step of generating an image of an object to be displayed in the real space, based on the information on the position and attitude of the imaging apparatus acquired in the first acquiring step, and the information on the parameters acquired in the second acquiring step, wherein in the first acquiring step, the position and attitude of the imaging apparatus is estimated from a captured image of the real space, by using the environment map.

Further features of the present invention will become apparent from the following description of exemplary embodiments with reference to the attached drawings.

### BRIEF DESCRIPTION OF THE DRAWINGS

FIG. 1 is a block diagram of an image processing apparatus and an HMD according to Embodiment 1;

FIG. 2 is a diagram for describing how deviation of a display position of a CG image is generated;

FIG. 3 is a diagram for describing how deviation of brightness of the CG image is generated;

FIG. 4 is a flow chart depicting an example of CG image display processing;

FIG. 5 is a flow chart depicting an example of processing to acquire an exposure correction value;

FIG. 6 is a block diagram of an image processing apparatus and an optical see-through type HMD;

FIG. 7 is a block diagram of an image processing apparatus and an HMD according to Embodiment 2;

FIG. 8 is a block diagram of an image processing apparatus and an HMD according to Embodiment 3;

FIG. 9 is a block diagram of an HMD according to Embodiment 4;

FIG. 10 is a graph indicating change of brightness of a real space, a background image and a CG image;

FIG. 11 is a graph indicating change of brightness in a case of correcting the CG image; and

FIG. 12 is a graph indicating change of brightness after performing frame interpolation for the background image.

### DESCRIPTION OF THE EMBODIMENTS

### Embodiment 1

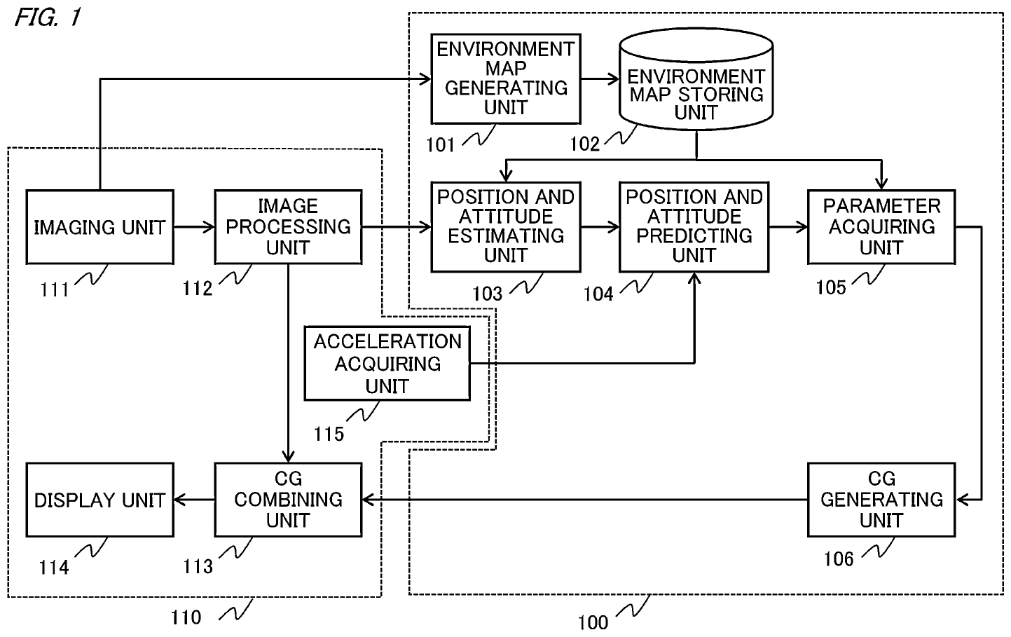

Embodiments of the present invention will be described with reference to the drawings. FIG. 1 is a block diagram of an image processing apparatus 100 and a head-mounted display (HMD) 110 according to Embodiment 1.

In an example described below, the image processing apparatus 100 is connected to the HMD 110 and is used in this state. However, a part of the functions of the image processing apparatus 100 may be executed by the HMD 110, or a part of the functions of the HMD 110 may be executed by the image processing apparatus 100. Further, the image processing apparatus 100 may be included in the HMD 110.

An imaging unit 111 of the HMD 110 is an imaging apparatus that captures an image of a real space which is a visual field of the user. A captured image of a real space (real space image), which is captured by the imaging unit 111, is sent to the image processing unit 112. The imaging unit 111 may include a plurality of image apparatuses. For example, the imaging unit 111 may include a pair of imaging apparatuses that captures images to be displayed as a background image, and a pair of imaging apparatuses that captures images to acquire the position and attitude of the HMD 110.

The image processing unit 112 acquires information on parameters related to the image processing (hereafter called “image processing parameters”) from the captured image. The information on the image processing parameters includes an exposure correction value, a white balance correction value, and the like. The exposure correction value includes gain, shutter speed and an aperture value. The white balance correction value includes such values as R/G and B/G. Further, information on the image processing parameters may include a noise-reduction value, which is a parameter of noise reduction (NR), an edge-enhancement value, which is a parameter of edge enhancement processing, a gamma-correction value, and the like.

In the following description, the image processing parameters are gain and shutter speed, which are exposure correction values, for example, but may be other parameters. To correct exposure at the optimum, the image processing unit 112 first evaluates the brightness of a captured image. If the captured image is excessively bright, the image processing unit 112 decreases the gain or increases the shutter speed, so as to calculate the exposure correction value to darken the captured image. If the captured image is dark, on the other hand, the image processing unit 112 increases gain or decreases the shutter speed, so as to calculate the exposure correction value to brighten the captured image.

The imaging unit 111 captures an image of the real space using the exposure correction value calculated by the image processing unit 112. Based on this image captured using the exposure correction value, the image processing unit 112 calculates the exposure correction value again. By repeating the calculation of the exposure correction value and the image capturing using the exposure correction value, the image processing unit 112 can control the exposure of the captured image at the optimum. The image processing unit 112 sends the captured image, after performing such image processing as exposure correction, to the CG combining unit 113.

The CG combining unit 113 generates a combined image of the captured image received from the image processing unit 112 and a CG image generated by a CG generating unit 106. A display unit 114 (display control unit) displays the combined image on an image display element, such as an organic light-emitting diode (OLED) installed in the HMD 110. By quickly completing the steps, from the image capturing to the display within the apparatus, the HMD 110 can reduce the delay of display of the real space image.

A generation method of a CG image which the CG combining unit 113 combines with the real space image will be described. The image processing unit 112 outputs a captured image, after performing various image processing, to a position and attitude estimating unit 103 of the image processing apparatus 100. The communication between the image processing apparatus 100 and the HMD 110 may be via cable or wireless.

The position and attitude estimating unit 103 estimates a position and attitude of the HMD 110 from the real space image received from the image processing unit 112. The information on the position and attitude can be estimated by a method using the simultaneous localization and mapping (SLAM), for example. In SLAM, an environment map used for estimating the position and attitude is generated in advance.

An environment map generating unit 101 generates an environment map using the real space image captured by the imaging unit 111. The environment map is information associating a captured image, information on the position and attitude of the imaging unit 111 at the time of capturing this image, and information on parameters of the image processing of the captured image with each other. The environment map enables efficiently estimating the position and attitude of the imaging unit 111.

Specifically, the environment map is created by generating a key frame, including the following information. The key frame includes a captured image, and the following information associated with the captured image.
ID of key frame
position and attitude of imaging apparatus (imaging unit 111) associated with the key frame
captured image associated with the key frame
image coordinates (x, y) of a feature point extracted from the captured image of the key frame
number of feature points extracted from the captured image of the key frame
dispersion value of feature points at the image on the captured image of the key frame (e.g. a numeric value determined by dividing image of key frame into 10×10 image blocks, and dividing a number of regions in a block having a feature point therein by a total number of regions and multiplying the result by 100)
reliability (index to indicate probability of alignment error determined by number of feature points and dispersion value) of the key frame
unique feature point ID assigned, with each extracted feature point being associated between captured images of plurality of key frames
three-dimensional coordinates (X, Y, Z) of feature point determined by triangulation based on position and attitude of imaging apparatus of each key frame, determined for feature points having same feature point ID associated above
ID of key frame in vicinity

The environment map includes a plurality of generated key frames, and is stored in an environment map storing unit 102. The position and attitude estimating unit 103 estimates the position and attitude of the imaging unit 111 using the environment map stored in the environment map storing unit 102. The estimated position and attitude of the imaging unit 111 can be regarded as the position and attitude of the HMD 110. The imaging apparatus used for generating the environment map may be an apparatus different from the imaging apparatus that captures the real space image to be combined with the CG image.

The CG generating unit 106 generates (renders) the CG image based on the position and attitude of the HMD 110 estimated by the position and attitude estimating unit 103. The real space image that is used to combine the CG image is an image of which capturing was delayed for the time required for the rendering processing captured with the captured image used for estimating the position and the attitude of the HMD 110. The position and attitude of the HMD 110 may change while rending the CG image. The change of the position and attitude of the HMD 110 may cause deviation of the display positions or orientations between the CG image and the real space image with which the CG image is combined.

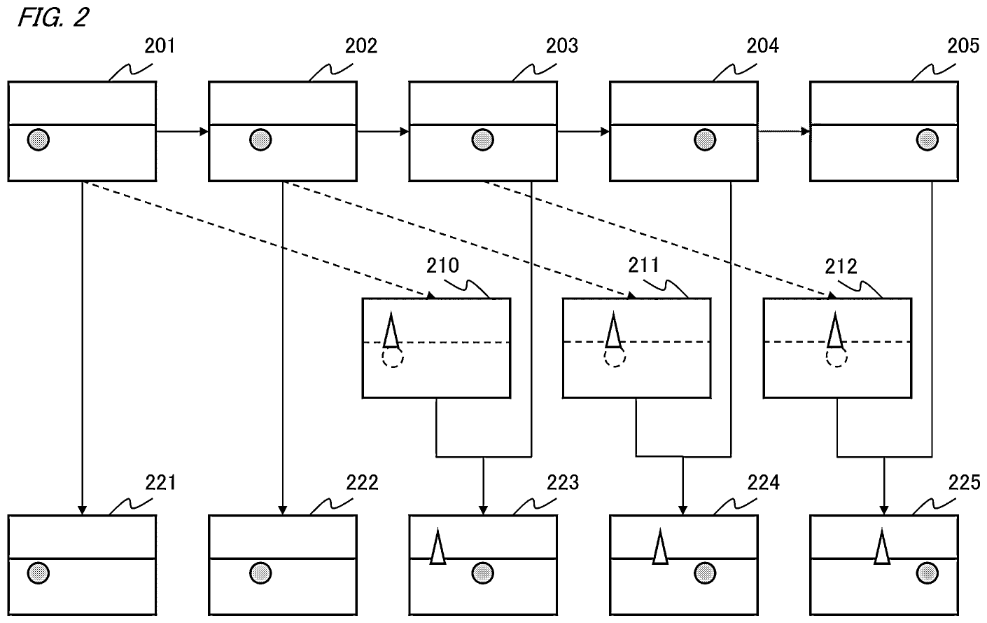

FIG. 2 is a diagram for describing how deviation of a display position of a CG image is generated. Real space images 201 to 205 are time-series images capturing a ball standing still while changing the position and attitude of the HMD 110.

CG images 210 to 212 are images rendering a triangular object (polygon), so as to contact the ball. The CG images 210 to 212 are images generated by rending the object using the position and attitude of the HMD 110 estimated from the real space images 201 to 203 respectively.

Combined images 221 to 225 are images generated by combining the CG images 210 to 212 with the real space images 201 to 205. In the example in FIG. 2, about 2 frames of delay were generated from the estimation of the position and attitude to the completion of rendering of the CG image. Therefore, the CG image 210 rendered using the position and attitude estimated from the real space image 201 is combined with the real space image 203.

In the combined image 223 generated by combining the CG image 210 and the real space image 203, the triangle, to be displayed in contact with the ball, is displayed at a position deviated from the ball. In the same manner, in the combined images 224 and 225 as well, the triangle, which is to be displayed in contact with the ball, is displayed at a position deviated from the ball. In this way, deviation of the display position is continuously generated.

For the same reason as the deviation of the display position, deviation of brightness or the like is also generated between the CG image and the real space image in the case where such optical characteristics as brightness of the real space image changes. This drops the optical consistency between the CG image and the real space image.

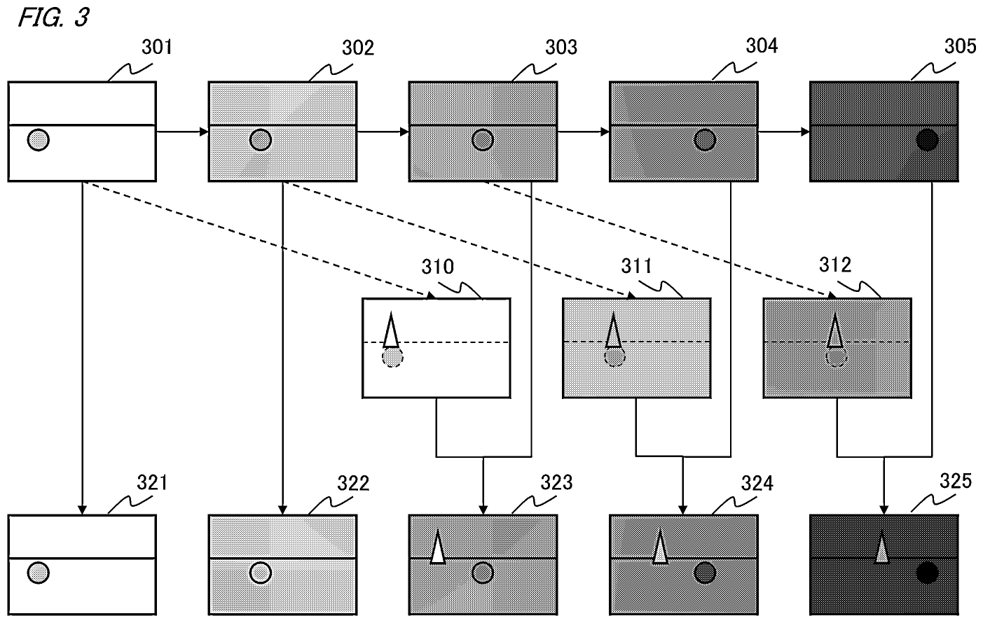

FIG. 3 is a diagram for describing how deviation of brightness of the CG image is generated. Real space images 301 to 305 are time-series images capturing a ball standing still while changing the ambient brightness, so as to darken gradually. In the example in FIG. 3 as well, the position and attitude of the HMD 110 are changing in the same manner as FIG. 2.

CG images 310 to 312 are images rendering a triangular object (polygon) reflecting the change of the ambient brightness. The CG images 310 to 312 are images generated by rending the object using exposure correction values of the real space images 301 to 303 respectively.

Combined images 321 to 325 are images generated by combining the CG images 310 to 312 with the real space images 301 to 305. In the example in FIG. 3, about 2 frames of delay have generated from the estimation of the position and attitude to the completion of rendering the CG image. Therefore, the CG image 310 rendered using an exposure correction value of the real space image 301 is combined with the real space image 303.

In the combined image 323 generated by combining the CG image 310 and the real space image 303, the image of the triangular object, which is superimposed, is displayed brighter than the peripheral area. In other words, the optical consistency between the CG image and the real space image is diminished. In the same manner, the combined images 324 and 325 as well are displayed in a state where the brightness of the peripheral area and the brightness of the object are deviated. In this way, the deviation of the brightness is generated continuously, where the optical consistency is diminished continuously.

As described in FIGS. 2 and 3, deviation is generated between the position an attitude of the HMD 110 at the time of starting the generation of the CG image and the position and attitude of the HMD 110 at the time of displaying the CG image. If the display timing of the CG image delays, display position, brightness or the like deviates between the real space image and the CG image due to the deviation of the position and attitude of the HMD 110 until the CG image is displayed. A method for reducing the deviation of the display position, brightness or the like between the real space image and the CG image will be described.

First a method for reducing the deviation of the display position of the CG image indicated in FIG. 2 will be described. A position and attitude predicting unit 104 in FIG. 1 predicts the position and attitude of the HMD 110 at the time of displaying the CG image, based on information on the current position and attitude of the HMD 110, and information on acceleration acquired by an acceleration acquiring unit 115 of the HMD 110. The information on the current position and attitude of the HMD 110 used for predicting the position and attitude may be the position and attitude estimated by the position and attitude estimating unit 103, or may be the position and attitude acquired by the acceleration acquiring unit 115.

The acceleration acquiring unit 115 includes an acceleration sensor, a gyro sensor, a geomagnetic sensor, and the like. The acceleration is a value indicating the changes of 3 rotary motions around the X axis, Y axis and Z axis of the HMD 110 (that is, attitude), and is also called the “3 degrees of freedom” (3DoF). The acceleration acquiring unit 115 may be a sensor that can acquired 6DoF instead of 3DoF. The 6DoF is a value corresponding to 6 motions, which are motions of 3DoF and the translational motions of the HMD 110 on the X axis, Y axis and Z axis (that is, position and attitude).

The acceleration acquiring unit 115 can acquire the position and attitude of the HMD 110 in a shorter time at a higher frame rate than the position and attitude estimating unit 103, hence a more recent position and attitude than the position and attitude estimated by the position and attitude estimating unit 103 can be acquired. This means that the acceleration acquiring unit 115 can acquire the position and attitude of the HMD 110 immediately before rendering. The acceleration acquiring unit 115 can acquire the history of the change of the position and attitude up to the current time at a high frame rate, therefore the position and attitude predicting unit 104 can predict the position and attitude several frames ahead.

The CG generating unit 106 generates a CG image based on the position and attitude of the HMD 110 predicted by the position and attitude predicting unit 104. Thereby deviation of the display position between the real space image and the CG image at the time of displaying the CG image is reduced. By improving the prediction accuracy, the position and attitude predicting unit 104 can reduce the deviation of the display position of the CG image from the real space image to the level where the deviation is not conspicuous.

Next a method for improving the optical consistency by reducing the deviation of the brightness of the CG image indicated in FIG. 3 will be described. A parameter acquiring unit 105 acquires information on the image processing parameter corresponding to the position and attitude of the HMD 110. The parameter acquiring unit 105 can acquire the information from the environment map where the information on the image processing parameters is associated with each key frame.

When the environment map is generated, the environment map generating unit 101 stores the information on the image processing parameters, used when the captured image of the key frame was captured, in the environment map storing unit 102 in association with each key frame. The information on the image processing parameters associated with each key frame includes exposure correction values, such as gain and shutter speed, for example. The environment map generating unit 101 can generate the environment map where the information on the position and attitude of the imaging apparatus (HMD 110) and the information on the image processing parameters are associated with each other using key frames.

The parameter acquiring unit 105 can acquire the exposure correction value, associated with the position and attitude of the HMD 110 predicted by the position and attitude predicting unit 104, from the environment map. The parameter acquiring unit 105 determines a key frame closest to the predicted position and attitude of the HMD 110, and acquires the exposure correction value of the determined key frame as the prediction value. The closest key frame can be a key frame of which difference of the position and attitude from the predicted position and attitude of the HMD 110 is the smallest.

The parameter acquiring unit 105 may determine a plurality of key frames close to the predicted position and attitude of the HMD 110, and interpolate exposure correction values by weighting in accordance with the difference from the position and attitude of each key frame. By predicting the exposure correction value based on a plurality of key frame, the parameter acquiring unit 105 can acquire a more accurate value.

The environment map generating unit 101 can generate the environment map in advance, which includes not only information of the exposure correction values but also of various image processing parameters. Thereby the parameter acquiring unit 105 can acquire information on various image processing parameters associated with the position and attitude of the HMD 110. The information on the image processing parameters associated with each key frame of the environment map includes at least one of: the exposure correction value, a white balance correction value, the gamma-correction value, the noise-reduction value, and the edge-enhancement value, for example. The information on the image processing parameters may be any one of: the exposure correction value, the white balance correction value, the gamma-correction value, the noise-reduction value, and the edge-enhancement value, or information combining these values arbitrarily.

The CG combining unit 113 generates a CG image based on the information on the position and attitude of the HMD 110 acquired (predicted) by the position and attitude predicting unit 104, and the information on the image processing parameters acquired by the parameter acquiring unit 105. Thereby the optical consistency between the real space image and the CG image is improved. The accuracy of the image processing parameters acquired by the parameter acquiring unit 105 depends on the prediction accuracy of the position and attitude predicting unit 104. Therefore, if the prediction accuracy of the position and attitude predicting unit 104 increases, the accuracy of the image processing parameters acquired by the parameter acquiring unit 105 improves.

In a case of allowing a delay of the display timing of the CG image, the parameter acquiring unit 105 may acquire the information on the image processing parameters, not based on the information on the position and attitude predicted by the position and attitude predicting unit 104, but based on the information on the position and attitude used for generating the CG image. In this case as well, the optical consistency between the real space image and the CG image improves compared with the case of generating the CG image without adjusting the image processing parameters.

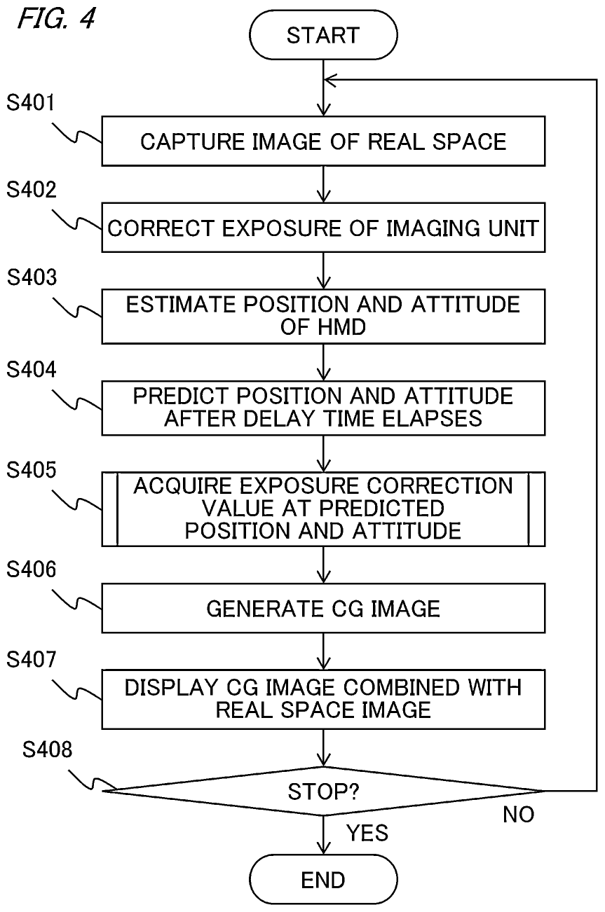

FIG. 4 is a flow chart depicting an example of CG image display processing. In step S401, the imaging unit 111 captures an image of a real space which is a visual field of the user. In step S402, the image processing unit 112 determines an exposure correction value, and corrects the exposure thereby. In step S403, the position and attitude estimating unit 103 estimates the position and attitude of the HMD 110 from the captured image, for which exposure correction and other image processing were performed in step S402, using the environment map stored in the environment map storing unit 102.

In step S404, the position and attitude predicting unit 104 predicts the position and attitude of the HMD 110 after a delay time, using the information of 3DoF or 6DoF acquired by the acceleration acquiring unit 115. The delay time may be a predetermined time, or may be a time corresponding to a predetermined number of frames. The delay time may be set in accordance with the size of the CG to be displayed, a number of CG images, or the like.

In step S405, the parameter acquiring unit 105 acquires the exposure correction value, associated with the position and attitude of the HMD 110 predicted in step S404, from the environment map. In step S406, the CG generating unit 106 generates (renders) the CG image using the information on the position and attitude of the HMD 110 predicted in step S404, and the exposure correction value acquired in step S405.

In step S407, a CG combining unit 113 combines the real space image and the CG image generated in step S406. The display unit 114 displays the combined image generated by the CG combining unit 113 on the display. The real space image to be combined with the CG image (captured image of the real space at the time of displaying the CG image) is the real space image captured immediately before combining.

In step S408, the imaging unit 111 determines whether imaging is stopped. If an instruction to stop imaging is received from the user, the imaging unit 111 ends the processing indicated in FIG. 4. If no instruction to stop imaging is received from the user, the imaging unit 111 returns to step S401, and continues the processing to display the CG image.

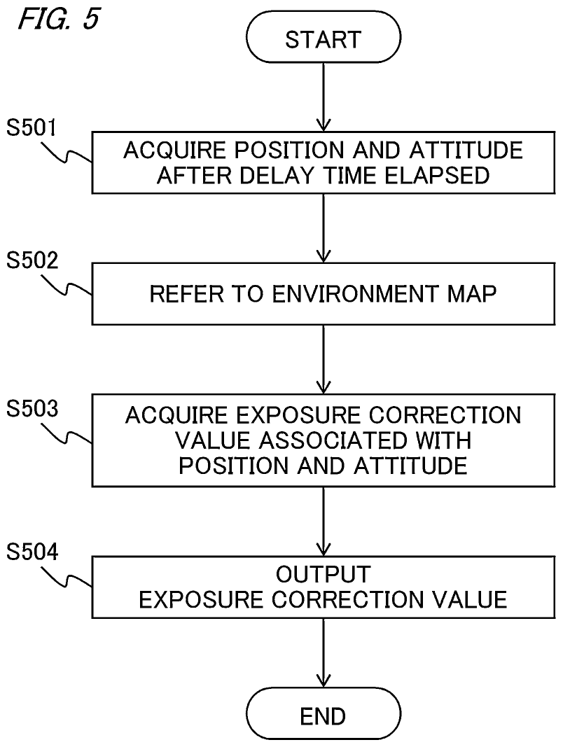

FIG. 5 is a flow chart depicting an example of processing to acquire the exposure correction value in step S405 in FIG. 4. In step S501, the parameter acquiring unit 105 acquires information on the position and attitude of the HMD 110 after the delay time predicted by the position and attitude predicting unit 104. In step S502, the parameter acquiring unit 105 refers to the environment map which includes the information on the image processing parameters, such as the exposure correction value. The environment map is stored in the environment map storing unit 102. In step S503, using the environment map which was referred to in step S502, the parameter acquiring unit 105 acquires the exposure correction value associated with the position and attitude of the HMD 110 after the delay time acquired in step S501. In step S504, the parameter acquiring unit 105 outputs the exposure correction value acquired in step S503 to the CG generating unit 106.

In Embodiment 1 described above, the image processing apparatus 100 acquires the image processing parameters associated with the position and attitude of the HMD 110 from the environment map, in which the information on the position and attitude of the HMD 110 and the information on image processing parameters are associated with each other, and generate the CG image thereby. Therefore, the image processing apparatus 100 can generate the combined image in which optical consistency between the real space image and the CG image is improved.

The image processing apparatus 100 may also predict the position and attitude of the HMD 110 at the time of displaying the CG image, and generate the CG image based on the predicted position and attitude. In this case, the image processing apparatus 100 can reduce the deviation of the display positions and the deviation of optical characteristics (e.g. brightness) between the CG image and the real space image when the CG image is displayed.

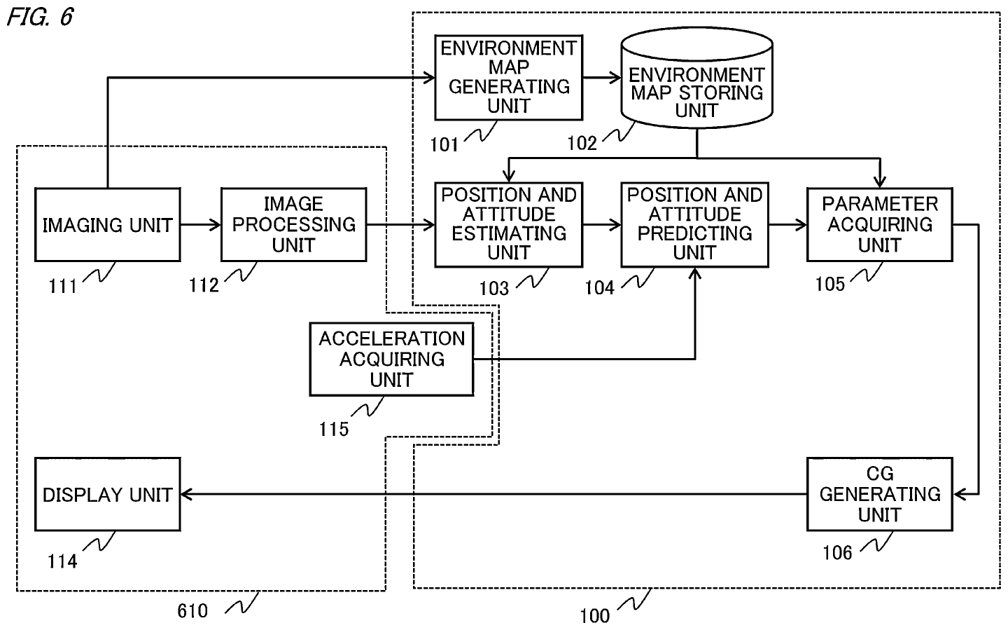

The HMD 110 according to Embodiment 1 is a video see-through type HMD including the CG combining unit 113 in the above description, but may be an optical see-through type HMD. FIG. 6 is a block diagram of the image processing apparatus and the optical see-through type HMD to which Embodiment 1 is applied. The optical see-through type HMD 610 does not include the CG combining unit 113. The other configuration of the HMD 610 and the configuration of the image processing apparatus 100 are the same as FIG. 1, hence description thereof will be omitted. The optical see-through type HMD 610 displays a CG image, generated by the CG generating unit 106 of the image processing apparatus 100, on the real space which the user is viewing via the display.

### Embodiment 2

Embodiment 1 is an example of acquiring the information on the image processing parameters, such as the exposure correction value, associated with the position and attitude of the HMD 110 after the delay time, using the environment map including the information on the imaging parameters. Embodiment 1 is based on the assumption that the brightness of the real space has not changed between the time when the environment map is constructed and the time when the user actually wears the HMD 110 and the CG image is superimposed and displayed.

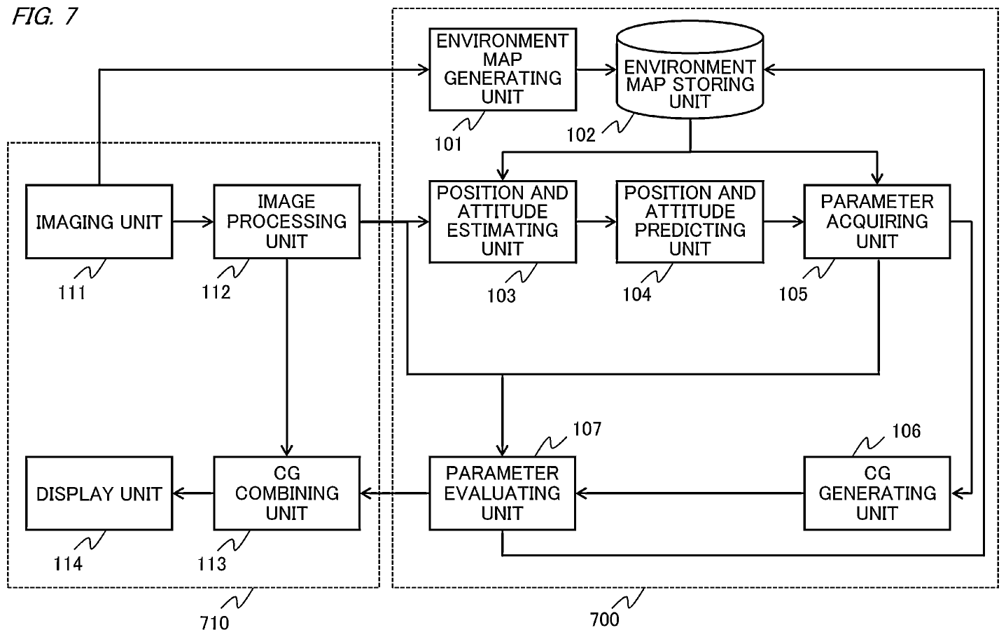

Embodiment 2 is an example based on the assumption that the brightness of the real space changes between the time when the environment map is constructed and the time when the user actually wears the HMD and the CG image is superimposed and displayed. FIG. 7 is a block diagram of an image processing apparatus 700 and an HMD 710 according to Embodiment 2. The image processing apparatus 700 includes a parameter evaluating unit 107 in addition to the configuration of the image processing apparatus 100 of FIG. 1. A composing element the same as Embodiment 1 is denoted with a same reference sign, and detailed description thereof will be omitted.

In the case where the brightness of the real space has changed since the time when the environment map generating unit 101 generated the environment map, the image processing parameters, which the parameter acquiring unit 105 acquired from the environment map, may not be suitable for the brightness of the real space at the time of displaying the CG image. Therefore, the parameter evaluating unit 107 acquires and compares the information on the image processing parameters acquired from the environment map, and the information on the image processing parameters which the image processing unit 112 determined for the real space at the time of displaying the CG image. The real space at the time of displaying the CG image may be the real space immediately before the CG image is combined.

In the case where the information on the image processing parameters is the exposure correction value, the parameter evaluating unit 107 compares the exposure correction value acquired from the environment map and the exposure correction value which the image processing unit 112 determined for the real space at the time of displaying the CG image. If the acquired 2 correction values are different, the parameter evaluating unit 107 regards this because the brightness of the real space has changed. In the case where the acquired 2 exposure correction values are different, the parameter evaluating unit 107 updates the exposure correction value of the environment map stored in the environment map storing unit 102, based on the exposure correction value determined by the image processing unit 112.

Among the key frames of the environment map, a key frame, which becomes a target of updating the exposure correction value, is a key frame of which exposure correction value was acquired by the parameter evaluating unit 107. The parameter evaluating unit 107 may include a key frame, of which difference of the position and attitude from the update target key frame is a predetermined threshold or less, in the target of updating the exposure correction value.

In the case where the exposure correction value acquired from the environment map and the exposure correction value, which the image processing unit 112 determined for the real space at the time of displaying the CG image, are different, the CG generating unit 106 generates the CG image using the exposure correction value determined by the image processing unit 112. In other words, the CG generating unit 106 generates the CG image based on the position and attitude of the HMD 110 predicted by the position and attitude predicting unit 104 and the exposure correction value determined by the image processing unit 112.

In Embodiment 2 described above, the image processing apparatus 700 updates the information on the image processing parameters of the environment map in the case where the information on the image processing parameters acquired from the environment map, and the information on the image processing parameters determined by the imaging apparatus (image processing unit 112), are different. Therefore, even in the case where the brightness of the real space changed after the environment map is generated, the image processing apparatus 700 can update the environment map, and thereby acquire the exposure correction value in accordance with the brightness of the real space after the change.

### Embodiment 3

Embodiment 1 is an example of predicting the position and attitude of the HMD 110 at the time of displaying the CG image in advance, before rendering the CG image. Embodiment 3, on the other hand, is an example of correcting information on the position and attitude of the HMD 110 based on the information on acceleration of the HMD 110 at the time of displaying the CG image, after rendering the CG image. The information on acceleration at the time of displaying the CG image may be information on acceleration immediately before the CG image is combined with the real space image.

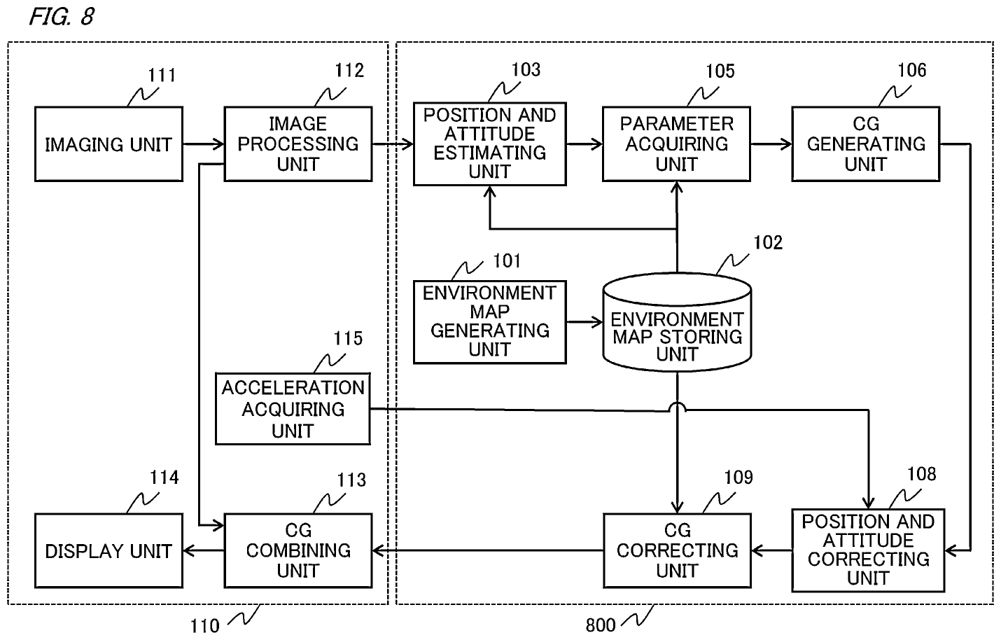

FIG. 8 is a block diagram of an image processing apparatus 800 and the HMD 110 according to Embodiment 3. The HMD 110 has the same configuration as Embodiment 1. The image processing apparatus 800 has the configuration of the image processing apparatus 100 in FIG. 1, where a position and attitude correcting unit 108 and a CG correcting unit 109 are included instead of the position and attitude predicting unit 104. A composing element the same as Embodiment 1 is denoted with a same reference sign, and detailed description thereof will be omitted.

The image processing apparatus 800 corrects a CG image based on the information on acceleration acquired by the acceleration acquiring unit 115 at the time of displaying the CG image (immediately before the CG image is combined with the real space image). This method is the so called “post process”. By using the post process, the image processing apparatus 800 can generate a combined image, where no deviation is generated between the real space image and the CG image without predicting the position and attitude of the HMD 110 (imaging unit 111). Embodiment 3 is applied to the image processing apparatus 800 using the post process like this.

Exposure of the real space image captured by the imaging unit 111 has been corrected by the image processing unit 112. The real space image, of which exposure is corrected by the image processing unit 112, is inputted to the position and attitude estimating unit 103. The parameter acquiring unit 105 acquires an exposure correction value associated with the position and attitude estimated by the position and attitude estimating unit 103 based on the environment map. In the case of using the post process, however, the image processing apparatus 800 need not include the parameter acquiring unit 105. In this case, the image processing apparatus 800 can acquire the exposure correction value determined by the image processing unit 112.

The CG generating unit 106 generates (renders) the CG image using the position and attitude of the HMD 110 estimated by the position and attitude estimating unit 103, and the exposure correction value acquired by the parameter acquiring unit 105. However, if the CG combining unit 113 combines the rendered CG image with the real space image without any correction, the display positions thereof deviate because of the delay of the display timing.

Therefore the position and attitude correcting unit 108 corrects the position and attitude of the HMD 110 estimated by the position and attitude estimating unit 103, based on the information on acceleration acquired by the acceleration acquiring unit 115. Further, the CG correcting unit 109 also corrects the brightness of the CG image. The CG correcting unit 109 acquires an exposure correction value, associated with the position and attitude of the HMD 110 corrected by the position and attitude correcting unit 108, from the environment map. The CG combining unit 113 combines the CG image corrected by the CG correcting unit 109, with a captured image of the real space immediately before the combining.

In Embodiment 3 described above, the position and attitude correcting unit 108 corrects the information on the position and attitude of the HMD 110, based on the information on the acceleration of the HMD 110. The CG correcting unit 109 acquires the information on the image processing parameters associated with the corrected position and attitude of the HMD 110 from the environment map, and corrects the CG image based on the acquired image processing parameters. The image processing apparatus 800 includes the position and attitude correcting unit 108 and the CG correcting unit 109, and corrects the CG image using the post process, whereby the optical consistency between the CG image and the real space image in the combined image can be improved.

### Embodiment 4

Embodiment 4 is an example when the HMD includes 2 types of imaging units: a dedicated computer vision (CV) imaging unit to calculate the position and attitude; and a background imaging unit to capture an image of the real space.

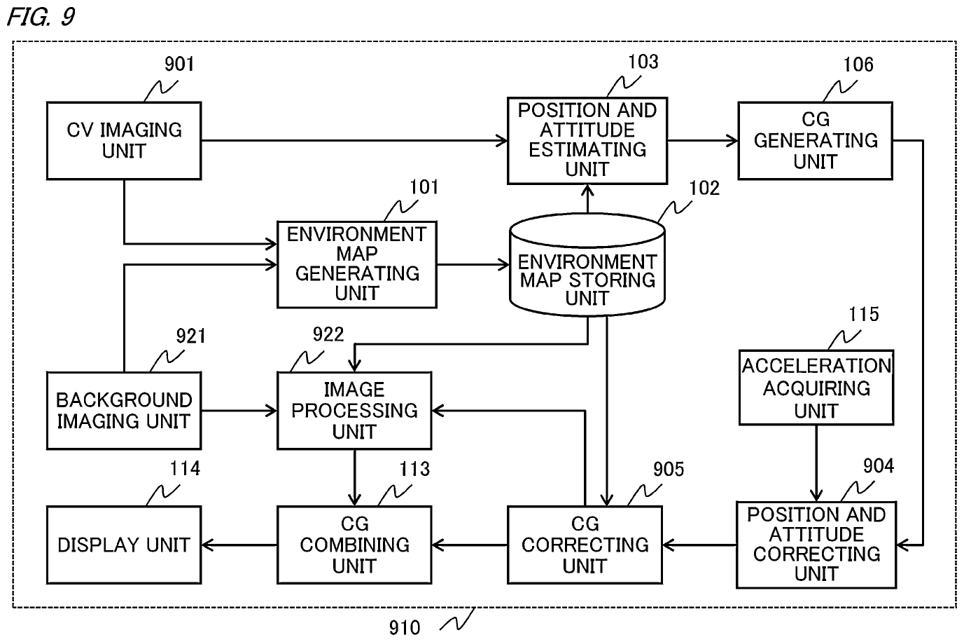

FIG. 9 is a block diagram of an HMD 910 according to Embodiment 4. The HMD 910 includes a part of the functions of the image processing apparatus 100 according to Embodiment 1. Embodiment 4 is applied to the HMD 910 which functions as an image processing apparatus. A composing element the same as the image processing apparatus 100 and the HMD 110 according to Embodiment 1 is denoted with a same reference sign, and detailed description thereof will be omitted.

A CV imaging unit 901 is an imaging apparatus which captures images at low resolution and at a high frame rate, and can calculate the position and attitude more frequently. For example, the CV imaging unit 901 captures images at a 90 FPS frame rate.

A background imaging unit 921 is an imaging apparatus which captures images at high resolution and at a low frame rate, and improves resolution of appearance of the real space image. For example, the background imaging unit 921 captures images at a 30 FPS frame rate.

In Embodiment 4, the CG image is corrected by the post process, just like Embodiment 3. The HMD 910 includes a position and attitude correcting unit 904 and a CG correcting unit 905. In the same manner as Embodiment 3, the position and attitude correcting unit 904 corrects the position and attitude of the HMD 910, estimated by the position and attitude estimating unit 103, based on the information on acceleration acquired by the acceleration acquiring unit 115. Further, the CG correcting unit 905 corrects the brightness of the CG image.

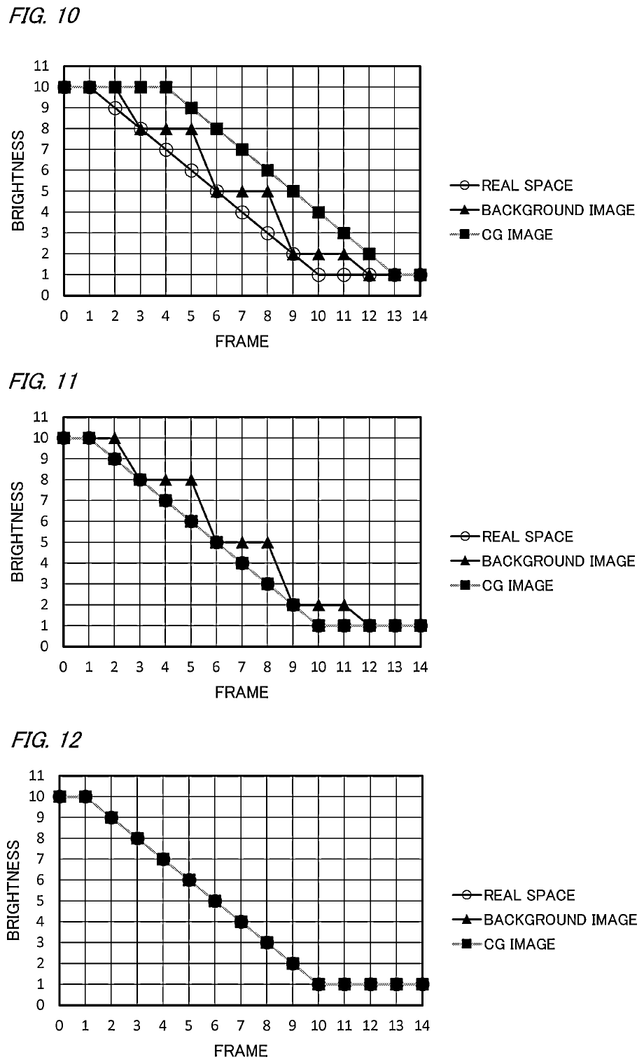

FIG. 10 is a graph indicating the change of brightness of a real space, a background image and a CG image. The ordinate indicates a level of brightness. The abscissa indicates a frame number. The brightness of the real space is the brightness of a captured image of the real space, which the CV imaging unit 901 captured. The brightness of the background image is the brightness of a captured image of the real space, which the background imaging unit 921 captured. FIG. 10 indicates a case where the real space becomes darker as the frame number progresses as time elapses.

When the brightness of the image of the real space captured by the CV imaging unit 901 changes, if the brightness of the real space is applied to the CG image without considering the delay time required for generating the CG image, the brightness of the CG image changes with this delay time. In the example in FIG. 10, the delay time is the time equivalent to 3 frames.

The brightness of the background image captured by the background imaging unit 921, on the other hand, does not change for 3 frames since the frame rate of the background imaging unit 921 is 30 FPS, which is ⅓ the frame rate of the CV imaging unit 901, which is 90 FPS. In other words, the brightness of the background image changes every 3 frames, in accordance with the ambient brightness. Since the brightness of the background image (real space image) and the brightness of the CG image are different, the optical consistency of the combined image is diminished.

To prevent this, the position and attitude correcting unit 904 and the CG correcting unit 905 correct the CG image using the post process, so as to match with the brightness of the real space at the time of displaying the CG image. FIG. 11 is a graph indicating the change of the brightness of the real space, the background image and the CG image in a case where the CG image was corrected. In FIG. 11, the graph of the brightness of the CG image overlaps with the graph of the brightness of the real space. By correcting the CG image in accordance with the image of the real space captured by the CV imaging unit 901, the brightness of the CG image changes in accordance with the brightness of the real space.

However, the brightness of the background image (real space image) captured by the background imaging unit 921 changes in accordance with the ambient brightness every 3 frames, hence the brightness of the background image becomes different from the brightness of the CG image depending on the frame. In the situation in FIG. 11 as well, the optical consistency in the combined image of the real space image and the CG image is diminished.

To prevent this, the image processing unit 922 corrects the real space image at 30 FPS using projection transformation or the like, and performs frame interpolation so as to be 90 FPS. The image processing unit 922 can perform the frame interpolation based on the position and attitude corrected by the position and attitude correcting unit 904.

The image processing unit 922 further acquires an exposure correction value corresponding to the position and attitude of an interpolated frame from the environment map, and corrects the brightness of this frame. FIG. 12 is a graph indicating the change of brightness after the frame interpolation of the background image. In FIG. 12, the graph of the brightness of the background image overlaps with the graph of the brightness of the real space and the CG image. In other words, the brightness of the background image (real space image) changes according to the change of the brightness of the CG image. The CG combining unit 113 generates a combined image by combining the real space image after the image processing unit 922 performed the frame interpolation and the CG image corrected by the CG correcting unit 905.

In Embodiment 4 described above, in the case where the frame rate of the image captured by the background imaging unit 921 is different from the frame rate of the image captured by the CV imaging unit 901, the HMD 910 corrects the background image (real space image) captured by the background imaging unit 921. The HMD 910 corrects the real space image to be combined with the CG image, using the information on the position and attitude of the HMD 910 corrected by the position and attitude correcting unit 904 and image processing parameters which the image processing unit 922 acquired from the environment map.

Specifically, in a case where the frame rate of the image captured by the background imaging unit 921 is smaller than the frame rate of the image captured by the CV imaging unit 901, the HMD 910 performs the frame interpolation for the real space image to be combined with the CG image. Using the corrected information on the position and attitude of the HMD 910 and the image processing parameters associated with this position and attitude, the HMD 910 interpolates the frames of the real space image so that the frame rate of the real space image becomes the frame rate of the image captured by the background imaging unit 921.

Therefore even in the case where the frame rate of the real space image to be combined with the CG image is different from the frame rate of the image captured by the CV imaging unit 901, the HMD 910 can improve the optical consistency between the real space image and the CG image.

### Embodiment 5

Embodiment 5 is an example where the information on the image processing parameters includes information on the light source (light source information) in the real space. Embodiment 5 is applicable to the HMD and the image processing apparatus of Embodiments 1 to 4 respectively. In the following, a case of applying Embodiment 5 to the HMD 110 and the image processing apparatus 100 will be described, but Embodiment 5 can also be applied to the HMD and the image processing apparatus of Embodiments 2 to 4.

Besides the method of matching the brightness of the CG image with the brightness of the real space image, a known method for establishing optical consistency between the real space image and the CG image is a method of drawing shadows, reflections and the like on the CG based on the light source information. The light source information includes information on the position, intensity and the like of the light source, and the reality of the CG image is improved by drawing shadows and reflections in accordance with the light source information.

The image based lighting (IBL) is known as a method to simply implement real reflection. In IBL, the real space image of a 360° is acquired in advance, and it is determined which part of the 360° image is used as the reflection image, based on the position and attitude of the HMD 110. Therefore, as described in Embodiment 1, if display of the CG image delays with respect to the real space image, a delay is also generated in the reflection image applied by IBL.

Hence the environment map generating unit 101 stores the light source information in the environment map storing unit 102 as information on the image processing parameters associating with the key frame. By generating the environment map including the light source information, the parameter acquiring unit 105 or the CG correcting unit 905 can acquire the light source information associated with the real space image to be combined with the CG image, from the environment map.

According to Embodiment 5 described above, the HMD 110 can improve the optical consistency between the real space image and the CG image using the light source information included in the environment map. Further, the position and attitude predicting unit 104 of the image processing apparatus 100 predicts the position and attitude of the HMD 110 at the time of displaying the CG image, whereby delay in applying the light source information to the CG image is improved.

Whereas preferred embodiments of the present invention have been described, the present invention is not limited to these embodiments, and can be modified or changed in various ways within the scope of the spirit thereof. These embodiments may be combined as required within the scope of the spirit of the invention.

Each functional unit of the image processing apparatus and the HMD according to Embodiments 1 to 3 (see FIG. 1, FIG. 6, FIG. 7 and FIG. 8), and each functional unit of the HMD according to Embodiment 4 (see FIG. 9) may or may not be an independent hardware unit. The functions of at least 2 functional units may be implemented by a common hardware unit. Each of a plurality of functions of 1 functional unit may be implemented by an independent hardware unit. At least 2 functions of one functional unit may be implemented by a common hardware unit. Further, each functional unit may or may not be implemented by a hardware unit. For example, the apparatus may include a processor and a memory storing a control program, and the functions of at least a part of the functional units of the apparatus may be implemented by the processor reading the control program from the memory, and executing the program.

According to the present invention, a CG image, of which optical consistency with the real space is improved, can be generated.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-205032, filed on Dec. 5, 2023, which is hereby incorporated by reference herein in its entirety.

What is claimed is:

1. An image processing apparatus comprising one or more processors and/or circuitry configured to:
perform a first acquiring processing to acquire information on a position and attitude of an imaging apparatus that captures an image of a real space which is a visual field of a user;
perform a second acquiring processing to acquire information on parameters on image processing, with the parameters being associated with the position and attitude of the imaging apparatus, from an environment map in which a captured image, information on the position and attitude, and information on the parameters on image processing are associated with each other; and
perform a generation processing to generate an image of an object to be displayed in the real space, based on the information on the position and attitude of the imaging apparatus acquired in the first acquiring processing, and the information on the parameters acquired in the second acquiring processing, wherein
in the first acquiring processing, the position and attitude of the imaging apparatus is estimated from a captured image of the real space, by using the environment map.

2. The image processing apparatus according to claim 1, wherein
in the first acquiring processing, the position and attitude of the imaging apparatus at a time of displaying an image of the object is predicted based on the information on the position and attitude of the imaging apparatus, and information on acceleration of the imaging apparatus, and
in the second acquiring processing, the information on the parameters, which is associated with the position and attitude of the imaging apparatus predicted in the first acquiring processing, is acquired from the environment map.

3. The image processing apparatus according to claim 2, wherein the one or more processors and/or the circuitry is further configured to
perform an update processing to update, in a case where the information on the parameters, which was acquired from the environment map in the second acquiring processing, is different from the information on the parameters which the imaging apparatus determined for the real space at a time of displaying the image of the object, the information on the parameters of the environment map, based on the information on the parameters which the imaging apparatus determined.

4. The image processing apparatus according to claim 2, wherein
in the generation processing, in a case where the information on the parameters, which was acquired from the environment map in the second acquiring processing, is different from the information on the parameters which the imaging apparatus determined for the real space at a time of displaying the image of the object, the image of the object is generated, based on the position and attitude of the imaging apparatus predicted in the first acquiring processing and the information on the parameters determined by the imaging apparatus.

5. The image processing apparatus according to claim 1, wherein
in the first acquiring processing, the information on the position and attitude of the imaging apparatus is corrected, based on information on acceleration of the imaging apparatus at a time of displaying the image of the object, and
in the second acquiring processing, the information on the parameters, which is associated with the position and attitude of the imaging apparatus corrected in the first acquiring processing, is acquired from the environment map.

6. The image processing apparatus according to claim 5, wherein the one or more processors and/or the circuitry is further configured to
perform a display control processing to perform control such that a combined image, in which the captured image of the real space and the image of the object are combined, is displayed, wherein
in the display control processing, in a case where a first frame rate of the captured image of the real space to be combined with the image of the object is different from a second frame rate of the captured image of the real space used for estimating the position and attitude of the imaging apparatus based on the environment map, the captured image of the real space to be combined with the image of the object is corrected, by using the information on the position and attitude of the imaging apparatus corrected in the first acquiring processing, and the information on the parameters acquired in the second acquiring processing.

7. The image processing apparatus according to claim 6, wherein
in the display control processing, in a case where the first frame rate is smaller than the second frame rate, frames are interpolated using the information on the position and attitude of the imaging apparatus corrected in the first acquiring processing, and the information on the parameters acquired in the second acquiring processing, so that the frame rate of the captured image of the real space to be combined with the image of the object becomes the second frame rate.

8. The image processing apparatus according to claim 1, wherein the one or more processors and/or the circuitry is further configured to
perform a display control processing to perform control so that a combined image, in which the captured image of the real space and the image of the object are combined, is displayed.

9. The image processing apparatus according to claim 1, wherein the one or more processors and/or the circuitry is further configured to
perform a display control processing to perform control so that the image of the object is displayed in the real space.

10. The image processing apparatus according to claim 1, wherein
the information on the parameters includes at least any of an exposure correction value, a white balance correction value, a gamma correction value, a noise reduction value, and an edge-enhancement value.

11. The image processing apparatus according to claim 1, wherein
the information on the parameters includes information on a light source in the real space.

12. A control method of an image processing apparatus, the control method comprising:
a first acquiring step of acquiring information on a position and attitude of an imaging apparatus that captures an image of a real space which is a visual field of a user;
a second acquiring step of acquiring information on parameters on image processing, with the parameters being associated with the position and attitude of the imaging apparatus, from an environment map in which a captured image, information on the position and attitude, and information on the parameters on image processing are associated with each other; and
a generation step of generating an image of an object to be displayed in the real space, based on the information on the position and attitude of the imaging apparatus acquired in the first acquiring step, and the information on the parameters acquired in the second acquiring step, wherein
in the first acquiring step, the position and attitude of the imaging apparatus is estimated from a captured image of the real space, by using the environment map.

13. A non-transitory computer-readable medium storing a program, wherein the program causes a computer to execute the control method comprising:
a first acquiring step of acquiring information on a position and attitude of an imaging apparatus that captures an image of a real space which is a visual field of a user;
a second acquiring step of acquiring information on parameters on image processing, with the parameters being associated with the position and attitude of the imaging apparatus, from an environment map in which a captured image, information on the position and attitude, and information on the parameters on image processing are associated with each other; and
a generation step of generating an image of an object to be displayed in the real space, based on the information on the position and attitude of the imaging apparatus acquired in the first acquiring step, and the information on the parameters acquired in the second acquiring step, wherein
in the first acquiring step, the position and attitude of the imaging apparatus is estimated from a captured image of the real space, by using the environment map.
